(19) United States
(12) Patent Application Publication
(10) Pub. No.: US 2019/0155222 A1
(43) Pub. Date: May 23, 2019

(54) CONVERTIBLE SMART WATCH

(71) Applicant: Seung Jae KIM, Seoul (KR)

(72) Inventor: Seung Jae KIM, Seoul (KR)

(21) Appl. No.: 16/321,109

(22) PCT Filed: Dec. 6, 2016
(86) PCT No.: PCT/KR2016/014204

§ 371 Date: Jan. 28, 2019

(30) Foreign Application Priority Data
Oct. 25, 2016 (KR) 10-2016-0139139

(51) Int. Cl. G04B 37/00; G06F 1/16; G04B 37/04

(52) U.S. Cl. CPC G04B 37/0083; G04B 37/0427; G04B 37/0033; G06F 1/163

(57) ABSTRACT

A convertible smart watch including: a frame having a groove; a watch body having an analog watch unit on one side and a smart watch unit on the other side leaning against each back, which is designed to be inserted to the groove; and a supporting member supporting the watch body so as to be rotatable, wherein one side is combined to the frame with a hinge such that watch body may rotate with respect to the frame between a first position being inserted to the groove and a second position being protruded to the front of the frame by leaving from the receiving groove.

### CROSS REFERENCE TO PRIOR APPLICATION

This application is a National Stage Patent Application of PCT International Patent Application No. PCT/KR2016/014204 (filed on Dec. 6, 2016) under 35 U.S.C. § 371, which claims priority to Korean Patent Application No. 10-2016-0139139 (filed on Oct. 25, 2016), which are all hereby incorporated by reference in their entirety.

### BACKGROUND

Example embodiments of inventive concepts may be applicable to a convertible smart watch, and more particularly, to a convertible smart watch which is freely convertible from smart watch to analogue watch and vice versa.

A smart watch is an embedded system wrist watch which has advanced functions compared to general watches. Initially, the embedded functions were calculating, translating, and playing games together with displaying time. But, presently, the functions may include various functions driven by mobile applications as well as phone call, receiving/sending voice and text messages, and playing audio and video files. Present smart watch generally includes camera, accelerometer, thermometer, altimeter, barometer, compass, chronograph, touch screen, touch screen, GPS, SD card, and chargeable and dischargeable battery.

The smart watch includes a display panel for performing functions and checking information. The design including a display panel may arouse ethnic sense of future oriented, but users who are accustomed to the traditional ethnic sense of analog watch having an hour hand and a minute hand may not choose the design.

So, a smart watch which is designed to look like an analog watch displaying a rotating hour hand a rotating minute hand is being required. But it is still hard to reproduce traditional ethnic sense of analog watch having a rotating hour hand and a rotating minute hand. In addition, checking time may be impossible when wireless communication condition is bad or a battery is discharged.

### SUMMARY

According to an exemplary embodiment, the inventive concept provides a convertible smart watch combining smart watch and analog watch, which is convertible from smart watch to analog watch and vice versa.

According to another exemplary embodiment, the inventive concept provides a convertible smart watch which is capable of converting without touching the watch body by finger tips or with minimum contact.

According to an exemplary embodiment of the inventive concept, a convertible smart watch includes a frame, a watch body, and a bracket. The frame includes a concave receiving groove. The watch unit is designed to be inserted to the receiving groove and combines an analog watch unit and a smart watch unit. Accordingly, one side of the watch body shows an analog watch and the other side shows a smart watch. The bracket supports the watch body so as to be rotatable. The bracket is rotatable between a first position and a second position against the frame. The first position is the position which one terminal of the bracket is combined to the frame by a hinge and the bracket is inserted to the receiving groove. The second position is the position the bracket being protruded to the front of the frame by being leaving from the receiving groove.

One between the analog watch and the smart watch is exposed on the front side of the frame, when the bracket is in the first position. The watch body provides a convertible smart watch which is rotatable against the bracket, when the bracket is in the second position.

Parts of the bracket except the part connected to the frame by a hinge may be a polygon or a folium forming symmetry based on the rotation axis of the watch body with respect to the bracket.

The rotating axis of the bracket with respect to the frame and the rotating axis of the watch body with respect to the bracket may be parallel.

The convertible smart watch further includes a smart watch on-off unit which operates the smart watch unit only when the smart watch being shown to the front of the frame.

The smart watch on-off unit includes an elastic bump and a touch switch. The elastic bump is protruded from one of the frame and the watch body so as to be elastically shortened. The touch switch is formed on one of the frame and the watch body and allows the smart watch unit to operate when being pressed. At this time, the touch switch is pressed by the elastic bump only when the watch body is inserted to one of the groove and the smart watch is exposed to the front of the frame.

The convertible smart watch further includes a locking unit for watch body not to fall off inadvertently from the receiving groove at the time that the watch body is inserted to the receiving groove.

The locking unit includes a hook interference, a hook, and a hook member. The hook interference is prepared on the bracket. The hook is interference by the hook interference. The hook member is installed on the frame so as to be elastically biased in the direction of the protruding from the inner surface of the receiving groove. At this time, the hook is protruded so as to be in interference by the hook interference to fix the bracket in the first position when the bracket is in the first position.

The convertible smart watch further includes a position change assistant spring to press the watch body elastically such that the bracket may be transferred to the second position, when the hook is free from the hook interference.

According to the inventive concept, a convertible smart watch includes a smart watch unit and an analog watch unit at the same time standing against their back and is convertible to show between the smart watch and the analog watch. Accordingly, a user may choose a smart watch or an analog watch with just one watch differently for dress, mood of the meeting, and so on.

According to the inventive concept, the convertible smart watch has structure of a watch body being connected to the frame with a bracket such that the smart watch may be converted into the analog watch, or the analog watch may be converted into the smart watch while being worn on the wrist.

According to the inventive concept, the convertible smart watch has structure of a watch body being inserted to a receiving groove with closed rear so as to be detachable. So, this prevents the analog watch or the smart watch of the watch body from being contacted by the wrist. Also, the smart watch and the analog watch may be convertible without contacting by the finger end or minimizing contact such that the watch body may not be rusted or contaminated by germs or sweat.

Also, the convertible smart watch may show time on the analog watch unit even if the smart watch unit not being available in battery discharge or in bad wireless communication condition.

### BRIEF DESCRIPTION OF THE DRAWINGS

FIGS. 1 through 5 are perspective views illustrating converting process from convertible smart watch to analog watch successively according to an exemplary embodiment of the present inventive concept; and

FIG. 6 is a cross-sectional diagram along the line of VI-VI of FIG. 1, and FIG. 7 is a cross-sectional diagram along the line of VII-VII of FIG. 5.

### DETAILED DESCRIPTION

Various example embodiments will be described more fully hereinafter with reference to the accompanying drawings. The terminology used herein is for the purpose of describing particular example embodiments and may be varies according to the user's purpose or conventional custom in the art. Accordingly, definition of the terminology should be interpreted as having a meaning that is consistent with their meaning in the context of the relevant art.

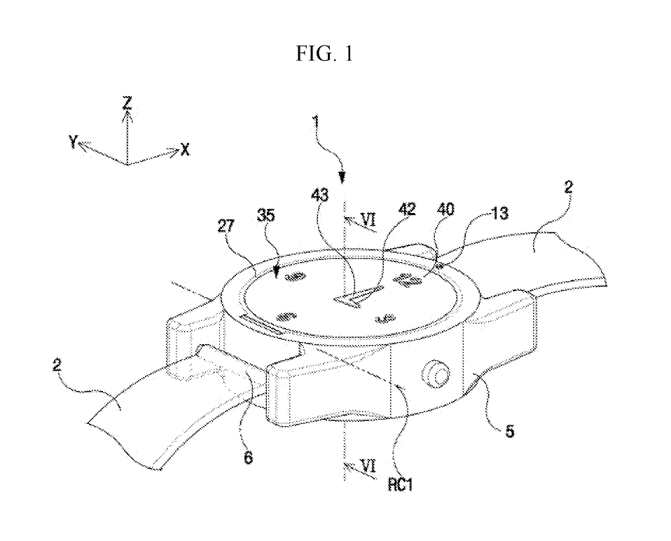

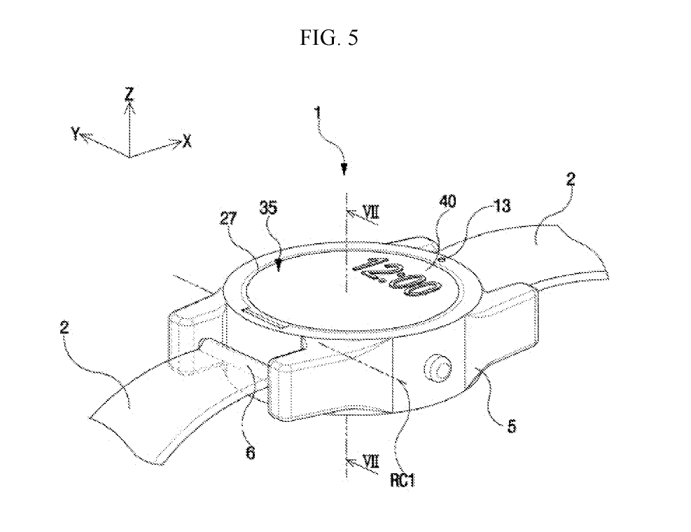

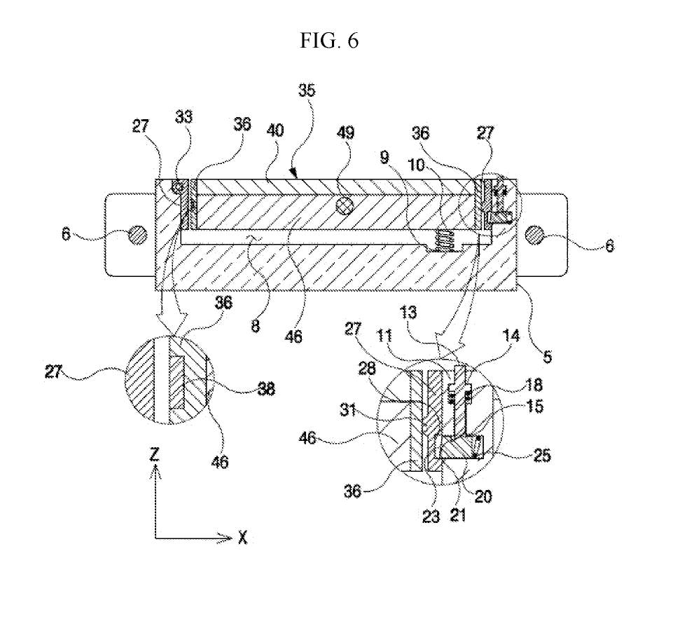

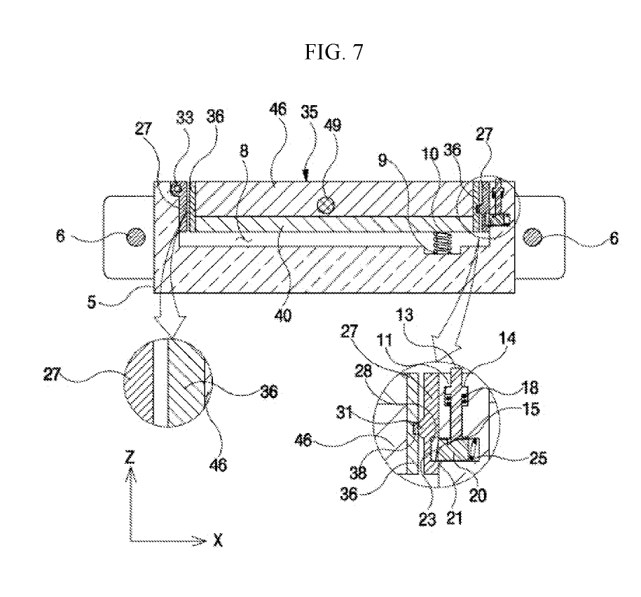

FIGS. 1 through 5 are perspective views illustrating converting process from convertible smart watch to analog watch successively according to an exemplary embodiment of the present inventive concept. FIG. 6 is a cross-sectional diagram along the line of VI-VI of FIG. 1, and FIG. 7 is a cross-sectional diagram along the line of VII-VII of FIG. 5. Referring to FIGS. 1 and 6, a convertible smart watch 1 includes a frame 5, a watch body 35, and a supporting member 27. The frame 5 includes a groove 8 formed in a circular shape at the center. The watch body 35 is inserted to the groove 8 so as to be detachable. Both longitudinal ends of the frame 5 include strap supporting bars 6 and straps 2 for the frame 5 to be worn on the wrist.

The watch body 35 includes an analog watch unit 35 and a smart watch unit 46. The analog watch unit 40 and the smart watch unit 46 are combined against each back. The watch body 35 shows an analog watch at one side and a smart watch at the other side. The watch body 35 further includes a bezel 36 for wrapping edges of the analog watch unit 40 and the smart watch unit 46.

The analog watch unit 40 tells time through an hour hand 42 and a minute hand 43 being attached and rotating on one side of the watch body 35. The analog watch unit 40 includes mechanical movement or quartz movement to spin the hour hand 42 and the minute hand 43.

The smart watch unit 46 includes a display panel installed on the other side of the watch body 35. The display panel shows time by displaying time with numbers. The smart watch unit 46 may provide various functions such as a calculator, a translator, a game console, and so on through mobile applications as well as telling time, phone call, sending/receiving voice and message. The smart watch unit 46 includes a camera, an accelerometer, a thermometer, an altimeter, a barometer, a compass, a chronograph, a touch screen, GPS, an SD card, a chargable/dischargable battery, and so on.

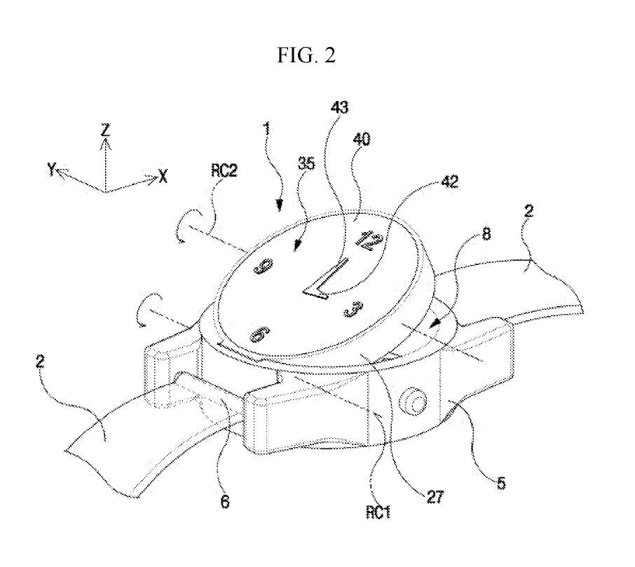

The supporting member 27 supports the watch body 35 so as to be rotatable on the basis of rotating axis RC2 (referred to FIG. 2) of the watch body.

One side of the supporting member 27 is connected to the periphery of the receiving groove 8 of the frame 5 by a hinge. Accordingly, the supporting member 27 is rotatable with respect to the frame 5 on the basis of the rotating axis RC1. Additionally speaking, the supporting member 27 is rotatable on the basis of the rotating axis RC1 between the first position and the second position. The first position is the position to which the supporting member is inserted in the receiving groove 8. The second position is the position that the supporting member 27 is protruded to the front of the frame 5 from the receiving groove 8.

Reference number 33 is a connecting pin for connecting the supporting member 27 to the frame so as to be rotatable. The connecting pin is extended along the rotating axis RC1 of the supporting member.

Reference number 49 is a pin connecting the watch body 35 to the frame 5 so as to be rotatable, which is extended along with the rotating axis RC2 of the watch body.

The part except the part combined to the frame 5 by a hinge of the supporting member 27 is a ring shape and has symmetry based on the rotating axis RC2 of the watch body. The ring shape is a circular shape with its center empty corresponding to a disk shape of the watch body 35.

But, the shape of the watch body 35 and the supporting member 27 is not restricted to a disc shape and a circle, but the shape could be a closed curve besides polygons such as a quadrangle and a hexagon, or a circle. Also, the shape of the supporting member 27 may be an open curve.

According to an exemplary embodiment, the rotating axis RC1 of the supporting member and the rotating axis RC2 of the watch body are in parallel, but they may not be in parallel.

As shown in FIGS. 1, 5, 6, and 7, the watch body 35 is inserted to the receiving groove 8 when a pair of supporting members 27 is in the first position such that the watch body 35 may not be rotated with respect to the supporting member 27 to show one of the analog watch and the smart watch to the front of the frame 5. FIGS. 1 and 6 illustrates that the analog watch is shown to the front of the frame 5, and FIGS. 5 and 7 illustrates that the smart watch is shown to the front of the frame 5.

As shown in FIGS. 2 through 4, the watch body 35 may be rotated based on the rotating axis RC2 of the watch body when the pair of supporting members 27 is in the second position.

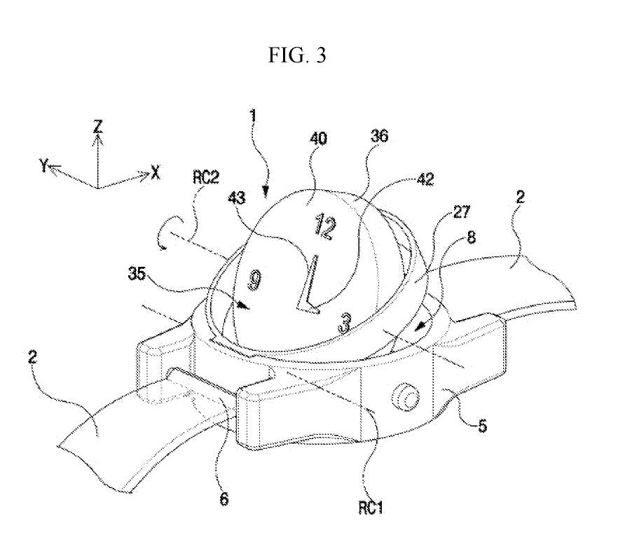

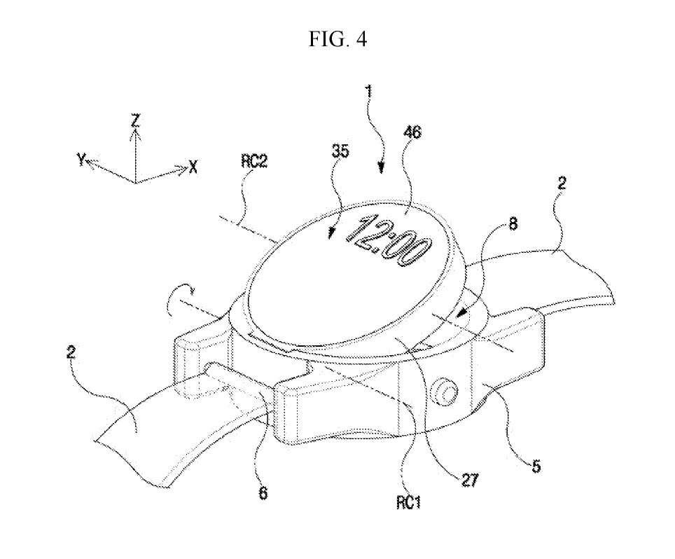

As shown in FIGS. 1 and 6, it is assumed that the analog watch is shown to the front of the frame 5 while the watch body 35 and the supporting member 27 being inserted to the receiving groove 8. The supporting member 27 moves to the second position which is protruding to the front when the supporting member 27 rotates. After then, as shown in FIGS. 3 and 4, the watch body 35 overlaps with the supporting member 27 while the smart watch being exposed to the front when the watch body 35 rotates halfway. And, as shown in FIGS. 5 and 7, the supporting member 27 returns to the first position for the watch body 35 to be inserted to the receiving groove 8 resulting the smart watch being protruded to the front of the frame 5 when the supporting member 27 rotates in an opposite direction compared to when being protruded.

The convertible smart watch 1 has a composition of the watch body 35 being inserted to the receiving groove 8 whose rear side is blocked so as to be detachable. Accordingly, the analog watch or smart watch of the watch body 35 may not contact the wrist even if being worn on the wrist. Also, it is possible to convert the smart watch and the analog watch of the watch body 35 without being touched by the finger end or with minimum touch by the finger end to prevent corrosion or pollution of the watch body caused by germs or sweat on the hand.

Referring to FIGS. 7 and 7, the convertible smart watch 1 may further include a smart watch unit on-off unit. The smart watch unit on-off unit allows the smart watch unit 46 to operate only when the smart watch is exposed to the front of the frame 5.

The smart watch unit on-off unit includes a pressing bump 31 and a touch switch 38.

The pressing bump 31 is protruded from the inner surface of the supporting member 27 toward the inside and is not located on the rotating axis RC2 of the watch body.

The touch switch 31 allows the smart watch unit 46 to operate when the touch switch 38 contacts and presses the pressing bump. On the other hand, the touch switch 38 allows the smart watch unit 46 to stop when the touch switch 38 may not touch the pressing bump 31.

Here, stopping the smart watch unit operation includes that the display panel may not show letters or patterns by blocking current from a chargable/dischargable battery to the display panel installed on one surface of the watch body 35.

The touch switch 38 is prepared on a bezel of the watch body 35 so as to be aligned with the pressing bump 31 only when the watch body 35 is inserted to the receiving groove 8 such that the smart watch is exposed to the front of the frame 5.

Accordingly, the smart watch unit 46 may operate by the touch switch 38 being touched and pressed by the pressing bump 16 only when the watch body 35 is inserted to the receiving groove 8 and the smart watch is exposed to the front of the frame 5 as shown in FIGS. 5 and 7, and the smart watch may not operate when the watch body 35 is inserted to the receiving groove 8, but the analog watch is exposed to the front of the frame 5 as shown in FIGS. 1 and 6. Meanwhile, the pressing bump 31 may be an elastic bump protruding toward inside of the supporting member 27 so as to be elastically contracted. Also, the bezel 36 may have a receiving groove for pressing bump (not shown) to be aligned with the pressing bump 31 such that the pressing bump 31 to be positioned therein when the watch body 35 overlaps the supporting member 27. The smart watch unit on-off unit may be embodied in many different ways.

The convertible smart watch 1 further includes a locking unit for locking the watch body 35 so as not to be left from the receiving groove 8. The locking unit includes a hook interference unit 28 prepared in the supporting member 27, a hook member 20 installed in the frame 5, and a push button member 13. The hook interference unit 28 may be a groove concaved toward inside from the outer circumference surface of the supporting member 27 by a step. Preferably, the hook interference unit 28 is prepared on a position separated further from the rotating axis RC1(referred to FIG1) of the supporting member than from the rotating axis RC2 of the watch body (referred to FIG. 2).

The hook member 20 is a member extended in parallel with the X-axis and inserted inside of the frame 5. A hook unit 23 is prepared on one end of the hook member 20 being interfered with the hook interfere unit 28. The other end of the hook member 20 is pressed elastically by a spring 25. Accordingly, the hook member 20 is elastically biased in a direction of the hook unit 23 protruding from inner surface of the receiving groove 8. The upper surface of the hook member 20 includes an inclined plane 15 being interfered with a push button member 13.

The push button member 13 is a member extended in parallel with the Z-axis and inserted inside of the frame 5. The push button member 13 includes a flange 14 extended in a radial shape inside the frame 5, and the flange 14 is pressed elastically by a spring 18. Accordingly, the push button member 13 is elastically biased in a direction of the upper unit being protruded to the upper surface.

The flange 14 is caught by a projected part 11 prepared on the frame 5 so as to limit raise of the push button member 13 and to prevent the push button member 13 from dropping from the frame 5. The lower part of the push button member 13 includes the inclined plane 15 being interfered by the inclined plane 21 of the hook member 20.

The upper part of the push button member 13 is protruded upward from the upper surface of the frame 5, and the hook interfere unit 28 of the hook member 20 is protruded from the inner peripheral surface. The hook member 20 is protruded from the inner peripheral surface of the receiving groove 8 until the hook interfere unit 28, because the upper inclined plane 21 of the hook member 20 and the lower inclined plane 15 of the push button member 13 are being interfered with each other.

The outer circumference surface of the supporting member 27 pushes the inclined plane of the hook unit 23 to make the hook member 20 retreat to the inside of the frame 5 when the supporting member 27 is rotated from the second position to the first position, and the supporting member 27 is moved to the first position. The hook interfere unit 28 of the supporting member 27 positioned in the first position is aligned with the hook unit 23 of the hook member 20, and the hook unit 23 is re-protruded by elastic power of the spring 25 to interfere with the hook interfere unit 28. Accordingly, the supporting member 27 and the watch body 35 supported thereby are fixed so as not to be dropped out from the receiving groove 8 inadvertently.

The push button member 13 descends when the upper unit of the push button member 13 is pressed while the supporting member 27 being locked at the first position, and then, the lower inclined plane 15 of the push button member 13 and the upper inclined plane 21 of the hook member 20 are interfered resulting the hook member 20 being retreated such that the hook member 23 is retreated inside the frame 5. Accordingly, interference between the hook unit 23 and the hook interference unit 28 released such that the supporting member 27 and the watch body 35 supported thereby may be movable to the second position. Meanwhile, the locking unit may be embodied as many different examples except for the example referring to FIGS. 6 and 7.

The convertible smart watch 1 may further include a position turning assistant spring 10 pressing the watch body 35 elastically. The position turning assistant spring helps the supporting member 27 and the watch body 25 supported thereby to move to a second position once interference between the hook unit 23 and the hook interference unit 28 being released.

The position turning assistant spring 10 may be positioned into a spring receiving groove 9 formed on the floor surface of the receiving groove 8. The position turning assistant spring 10 is pressed by the watch body 35 elastically when the supporting member 27 is at the first position.

As described above, the position turning assistant spring 10 presses the watch body 35 into the direction of leaving from the receiving groove 8, when the first position locking of the supporting member 27 is released by pushing the upper unit of the push button member 13. Accordingly, the supporting member 27 and the watch body 35 supported thereby move to the second position.

While the present invention has been particularly shown and described with reference to exemplary embodiments thereof, it will be understood that various changes in form and details may be made therein without departing from the spirit and scope of the following claims.

The present invention is applicable to a watch.

What is claimed is:

1. A convertible smart watch comprising:
a frame having a groove;
a watch body having an analog watch unit on one side and a smart watch unit on the other side leaning against each back, which is designed to be inserted to the groove; and
a supporting member supporting the watch body so as to be rotatable, wherein one side is combined to the frame with a hinge such that watch body may rotate with respect to the frame between a first position being inserted to the groove and a second position being protruded to the front of the frame by leaving from the receiving groove; and
wherein the watch body is inserted to the receiving groove and may not be rotate when the supporting member is in the first position such that one of the analog watch and the smart watch is exposed to the front of the frame ; and,
the watch body is rotatable with respect to the supporting member when the supporting member is in the second position.

2. The convertible smart watch of claim 1, wherein the supporting member has a polygonal shape or a looped curve shape being symmetry based on a rotating axis of the watch body with respect to the supporting member except for the part being hinged to the frame.

3. The convertible smart watch of claim 1, wherein the rotating axis of the supporting member with respect to the frame and the rotating axis of the watch body with respect to the supporting member are parallel with each other.

4. The convertible smart watch of claim 1, further comprising a smart watch on-off unit to operate the smart watch unit only when the smart watch is exposed to the front of the frame.

5. The convertible smart watch of claim 4, wherein the smart watch on-off unit has an elastic bump protruded installed inside the supporting member, and a touch switch formed on the side of the watch body and allows to operate the smart watch unit when being contacted and pressed, and
wherein the touch switch is contacted and pressed by the elastic bump only when the smart watch is exposed to the front of the frame by the watch body being inserted to the receiving groove.

6. The convertible smart watch of claim 1, wherein the watch body includes a locking unit prepared to lock the watch body from being dropped from the receiving groove.

7. The convertible smart watch of claim 6, wherein the locking unit includes a hook interference unit prepared in the supporting member, a hook unit interfered with the hook interference unit, and a hook member installed on the frame so as to be elastically biased into a direction of protruding from the inner surface of the receiving groove, and
wherein the supporting member is fixed at the first position by the hook being protruded so as to be interfered by the hook interference unit when the supporting member is at the first position.

8. The convertible smart watch of claim 7, further comprising a position change assistant spring to press the watch body elastically such that the supporting member may be transferred to the second position when interference of the hook unit and the hook interference unit has been released.
